(19) United States
(12) Patent Application Publication
(10) Pub. No.: US 2011/0018809 A1
(43) Pub. Date: Jan. 27, 2011

(54) PERSONAL IDENTIFICATION NUMBER INPUT DEVICE

(75) Inventors: Masatoshi Nochi, Shizuoka (JP); Toru Nishiie, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/841,234

(22) Filed: Jul. 22, 2010

(30) Foreign Application Priority Data
Jul. 24, 2009 (JP) 2009-173464

(51) Int. Cl. G06F 3/02

(52) U.S. Cl. 345/168

(57) ABSTRACT

According to one embodiment, a personal identification number input device includes a device main body having an input unit for a personal identification number, a shielding member attached to the device main body and configured to shield the input unit for an identification number from the outside, and a non-slip section provided on an outer side of the shielding member.

### CROSS-REFERENCE TO RELATED APPLICATIONS

This application is based upon and claims the benefit of priority from Japanese Patent Application No. 2009-173464, filed Jul. 24, 2009; the entire contents of which are incorporated herein by reference.

### FIELD

Embodiments described herein relate generally to a personal identification number input device for performing personal identification according to input of a personal identification number in a checkout terminal apparatus or the like.

### BACKGROUND

A personal identification number input device of this type includes a device main body and has, in an upper surface section of the device main body, an input unit for causing a user to input an identification number. In this personal identification number input device, the user operates the input unit to input a personal identification number of the user. However, when the user inputs the personal identification number, it is likely that input operation for the personal identification number is peeped from the outside.

Therefore, in the past, a shielding cover is attached to the device main body to shield the input unit from the outside.

The input unit is often pressed while the personal identification number input device is held in a hand of the user. Therefore, it is likely that the personal identification number input device slips from the hand and falls during the input operation for the personal identification number.

To prevent such a fall, in the past, there is known a personal identification number input device in which an uneven section is formed in a housing as a non-slip section to allow a user to hold the housing by putting fingertips on the uneven section (see, for example, JP-A-2000-316041).

However, in the past, there is no personal identification input device in which a non-slip section is provided in a shielding cover. Therefore, when the user inputs the personal identification number while holding the personal identification number input device in a hand, since the user cannot obtain sufficient non-slip feeling and hand-hold feeling, it is likely that the user drops and damages the personal identification number input device.

Therefore, there is a demand for a personal identification number input device that allows a user to obtain sufficient non-slip feeling and hand-hold feeling and prevent drop of and damage to the personal identification number input device during input operation for a personal identification number.

### BRIEF DESCRIPTION OF THE DRAWINGS

FIG. 1 is an external perspective view of a personal identification number input device according to a first embodiment of the invention;

FIG. 2 is a sectional view taken along line A-A in FIG. 1;

FIG. 3 is a side view of the personal identification number input device shown in FIG. 1;

FIG. 4 is an external perspective view of a personal identification number input device according to a second embodiment;

FIG. 5 is a sectional view taken along line B-B in FIG. 4;

FIG. 6 is an external perspective view of a personal identification number input device according to a third embodiment;

FIG. 7 is an external perspective view of a personal identification number input device according to a fourth embodiment; and

FIG. 8 is an external perspective view of a personal identification number input device according to a fifth embodiment.

### DETAILED DESCRIPTION

In general, according to one embodiment, a personal identification number input device includes: a device main body having an input unit for a personal identification number; a shielding member attached to the device main body and configured to shield the input unit for an identification number from the outside; and a non-slip section provided on an outer side of the shielding member.

### First Embodiment

Embodiments of the invention are explained in details below with reference to the accompanying drawings.

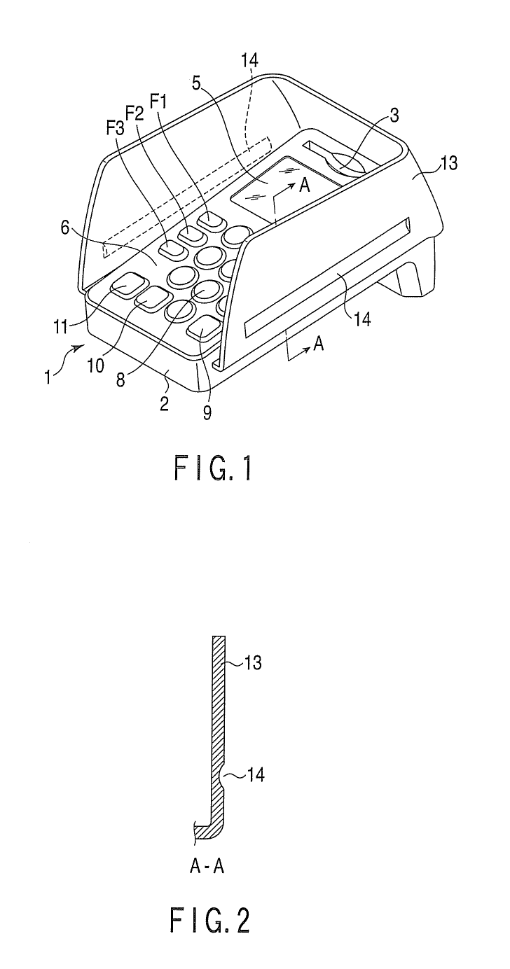

FIG. 1 is a perspective view of a personal identification number input device 1 according to a first embodiment.

The personal identification number input device 1 includes a device main body 2. A card insertion port 3 for causing a user to insert a credit card, a debit card, or the like is provided in an upper surface section of the device main body 2.

Further, on the upper surface section of the device main body 2, a display unit 5 configured to display, for example, a procedure of operation and an operation unit 6 are disposed. Input keys 8, an execution key 9, a correction key 10, a clear key 11, function keys F1, F2, and F3, and the like as an input unit for inputting a personal identification number are disposed on the operation unit 6.

A shielding cover 13 as a shielding member is detachably attached to the device main body 2 to prevent input operation from being peeped by others during personal identification number input. The shielding cover 13 is formed to rise along a peripheral section of the device main body 2. An upper surface section and a front section of the shielding cover 13 are opened.

The shielding cover 13 has both sidewall sections. Non-slip sections 14 are respectively formed on outer surface lower sides of both the sidewall sections along side sections of the device main body 2. As shown in FIG. 2, the non-slip sections 14 are formed in a concave shape in section.

The non-slip sections 14 are located in regions slightly higher than the side sections of the device main body 2 to allow the user to easily put fingertips on the non-slip sections 14 when the user holds and places the personal identification number input device 1 on the palm.

Since the non-slip sections 14 are respectively formed on both the sidewall sections of the shielding cover 13, regardless of whether the user is right-handed or left-handed, the user can put finger tips on one of the non-slip sections 14 to hold the device.

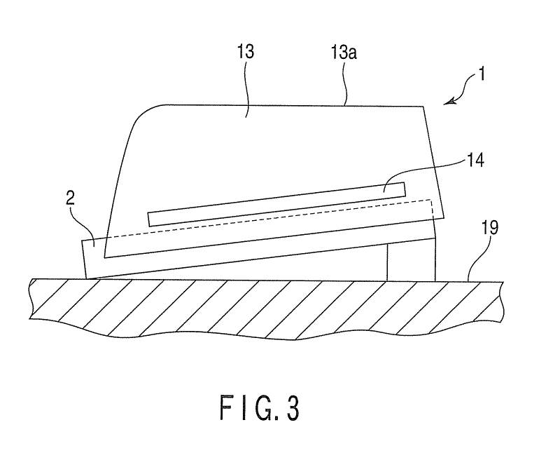

As shown in FIG. 3, the shielding cover 13 is formed such that an upper end surface 13a thereof is parallel to a setting surface 19 of the personal identification number input device 1. Therefore, shielding properties are improved.

The use of the personal identification number input device 1 is explained below.

First, the user holds the personal identification number input device 1 in one hand and places the personal identification number input device 1 on the palm with the operation surface side thereof faced upward. The user puts finger tips on the non-slip sections 14 of the shielding cover 13 to hold the personal identification number input device 1. The user inserts an IC card into the card insertion port 3 in this state. Subsequently, the user presses the input keys 8 with a finger tip of the other hand to input a personal identification number. Identification of the user is performed according to the input.

As explained above, according to this embodiment, the non-slip sections 14 are formed on the outer side sections of the shielding cover 13 and the user puts finger tips on the non-slip sections 14 to hold the personal identification number input device 1. Therefore, the user can obtain sufficient non-slip feeling and hand-hold feeling.

Therefore, it is possible to surely prevent the personal identification number input device 1 from falling during input operation for a personal identification number.

### Second Embodiment

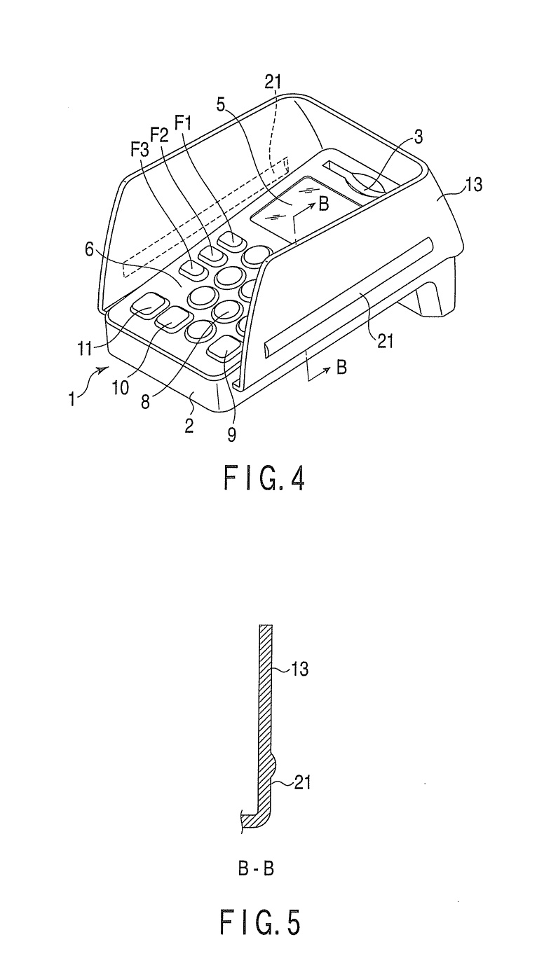

FIG. 4 is a perspective view of a personal identification number input device according to a second embodiment.

Components same as those explained in the first embodiment are denoted by the same reference numerals and signs and explanation of the components is omitted.

In the first embodiment, the non-slip sections 14 having a concave shape in section are formed in the shielding cover 13. However, in this second embodiment, as shown in FIG. 5, non-slip sections 21 having a convex shape in section are protrudingly provided integrally with the shielding cover 13.

In the second embodiment, as in the first embodiment, a user can obtain sufficient non-slip feeling and hand-hold feeling by putting finger tips on the non-slip sections 21 of the shielding cover 13. Therefore, it is possible to surely prevent the personal identification number input device 1 from falling during input operation for a personal identification number.

### Third Embodiment

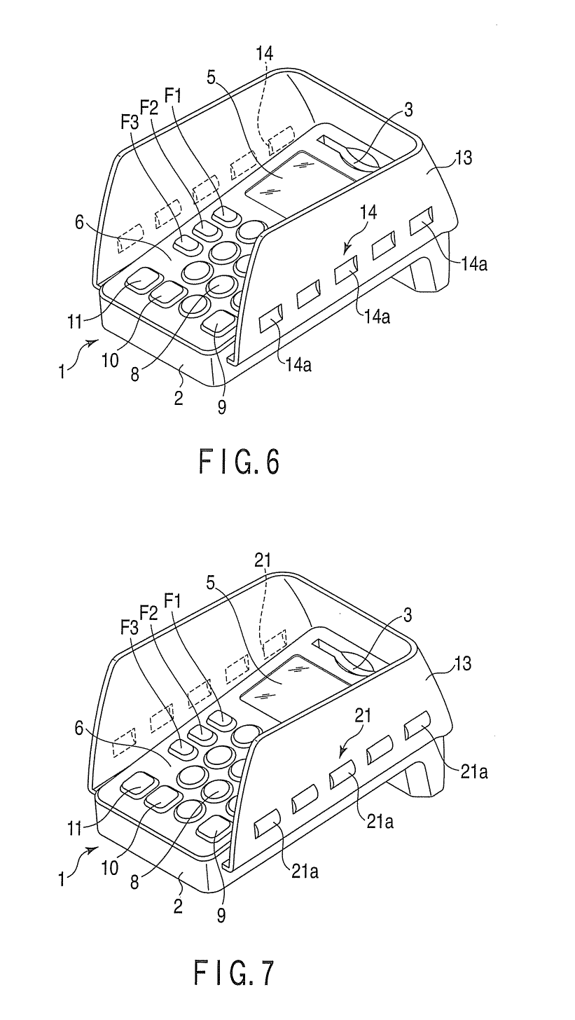

FIG. 6 is a perspective view of a personal identification number input device according to a third embodiment.

Components same as those explained in the first embodiment are denoted by the same reference numerals and signs and explanation of the components is omitted.

In the first embodiment, the non-slip sections 14 are formed linearly long on the outer side sections of the shielding cover 13. However, in this third embodiment, the non-slip sections 14 are divided into plural divided sections 14a. The divided sections 14a are linearly arrayed at predetermined intervals.

In the third embodiment, actions and effects same as those in the first embodiment can be obtained.

### Fourth Embodiment

FIG. 7 is a perspective view of a personal identification number input device according to a fourth embodiment.

Components same as those explained in the first embodiment are denoted by the same reference numerals and signs and explanation of the components is omitted.

In the second embodiment, the non-slip sections 21 are formed linearly long on the side sections of the shielding cover 13. However, in this fourth embodiment, the non-slip sections 21 are divided into plural divided sections 21a. The divided sections 21a are linearly arrayed at predetermined intervals.

In the fourth embodiment, actions and effects same as those in the second embodiment can be obtained.

### Fifth Embodiment

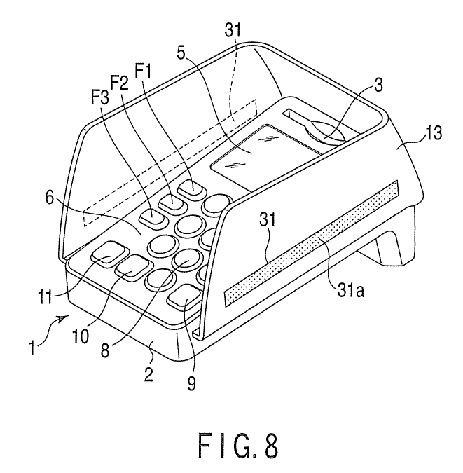

FIG. 8 is a perspective view of a personal identification number input device according to a fifth embodiment.

Components same as those explained in the first embodiment are denoted by the same reference numerals and signs and explanation of the components is omitted.

In this fifth embodiment, a large number of fine concave and convex portions 31a are formed on the outer side sections of the shielding cover 13 to form non-slip sections 31 in a straight shape.

In the fifth embodiment, actions and effects same as those in the first embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A personal identification number input device comprising:
a device main body having an input unit for a personal identification number;
a shielding member attached to the device main body and configured to shield the input unit for the identification number from the outside; and
a non-slip section provided on n outer side of the shielding member.

2. The device according to claim 1, wherein the shielding member has sidewall sections that rise from both sidewall sections of the device main body.

3. The device according to claim 2, wherein the non-slip section is provided on at least one of the sidewall sections of the shielding member.

4. The device according to claim 3, wherein the non-slip section includes a concave portion having a straight shape continuously formed on the sidewall section of the shielding member from one end side to the other end side of the sidewall section.

5. The device according to claim 3, wherein the non-slip section includes plural concave portions formed at predetermined intervals on the sidewall section of the shielding member from one end side to the other end side of the sidewall section.

6. The device according to claim 3, wherein the non-slip section includes a convex portion having a straight shape continuously formed on the sidewall section of the shielding member from one end side to the other end side of the sidewall section.

7. The device according to claim 3, wherein the non-slip section includes plural convex portions formed at predetermined intervals on the sidewall section of the shielding member from one end side to the other end side of the sidewall section.

8. The device according to claim 3, wherein the non-slip section includes a large number of fine concave and convex portions continuously formed on the sidewall section of the shielding member from one end side to the other end side of the sidewall section.

9. The device according to claim 3, wherein the non-slip section is located further on an upper side than the side section of the device main body.

10. The device according to claim 1, wherein an upper end surface of the shielding member is parallel to a placing surface of the device main body.
